(19) United States
(12) Patent Application Publication
(10) Pub. No.: US 2014/0149247 A1
(43) Pub. Date: May 29, 2014

(54) System and Method for Order Processing

(71) Applicant: Josh Frey, Washington, DC (US)

(72) Inventor: Josh Frey, Washington, DC (US)

(21) Appl. No.: 13/687,546

(22) Filed: Nov. 28, 2012

(51) Int. Cl. G06Q 30/06

(52) U.S. Cl. CPC G06Q 30/0637
USPC 705/26.7

(57) ABSTRACT

Here, we present a system/method for the business or e-commerce on-line (e.g. Internet or computer network) with respect to promotion, products, sales, distribution, percentages for different parties, chain of distributions and fulfillment, responsibilities and tasks, contracts between different parties, and awards. Different variations and examples are also presented here.

### BACKGROUND OF THE INVENTION

E-commerce and Internet have revolutionized the relationship between parties in transactions. However, the promotional deals and processes were not very efficient in the prior art. Thus, in this disclosure, we present a system and method for the business or e-commerce on-line with respect to promotion, products, sales, distribution, and chain of distributions and fulfillment. Some of the related art are listed in the IDS, attached. However, none of them teach the features of our invention listed below.

### SUMMARY OF THE INVENTION

One embodiment of the invention describes a system/method for the business or e-commerce on-line (e.g. Internet or computer network) with respect to promotion, products, sales, distribution, percentages for different parties, chain of distributions and fulfillment, responsibilities and tasks, contracts between different parties, and awards. Other examples are also given. The step-by-step ordering process and backend and front end structure are discussed in details. The relationships between different components are given.

### BRIEF DESCRIPTION OF THE DRAWINGS

Some examples and embodiments are described here for clarification, but the inventions are not limited to these examples:

FIG. 1 shows a typical method assembled according to an embodiment of the invention, for step-by-step ordering process.

FIG. 2 shows a typical method assembled according to an embodiment of the invention, for orders placed on the backend by the rep for their client.

FIGS. 3(a) and 3(b) shows a typical structure assembled according to an embodiment of the invention, for tree structure for ordering process, for front end web site and back end portal.

FIG. 4 shows a typical system or hardware assembled according to an embodiment of the invention, to implement one example of the ordering process.

### DETAILED DESCRIPTION OF THE PREFERRED EMBODIMENTS

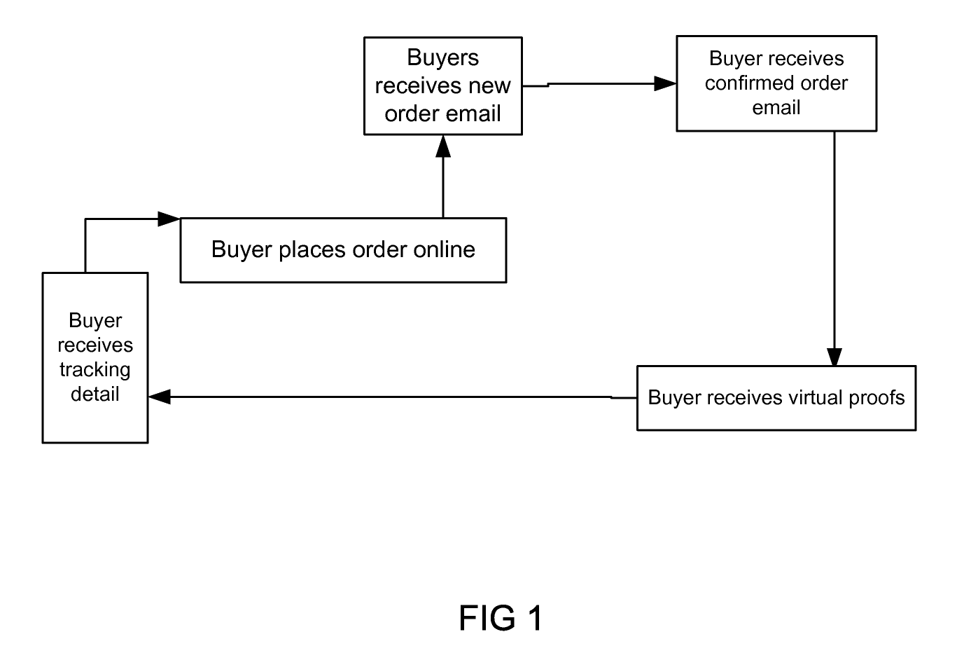

Here, we present a system/method for the business or e-commerce on-line (e.g. Internet or computer network) for step-by-step ordering process, as shown in FIG. 1.

For Orders Placed Online by the Buyer:

Step 1: Buyer Places Order through OnSalePromos.com (“OSP”)

Step 2: Buyer receives “OSP NEW ORDER” Email—it is the Order Estimate. This lets the buyer know that the order has been received, and OSP customer service is reviewing the details to confirm all pricing is correct.

Step 3: Buyer receives “OSP CONFIRMED ORDER” Email—it is the Order Approval. This lets buyer know that the order details have been reviewed, and they need to now click the CONFIRM ORDER (or CANCEL) button to have their order released to the factory. When the buyer clicks the button, the sales rep gets an email called “OSP CONFIRMED ORDER”, which tells Rep that they just made a sale (& $$$, e.g. dollar amount and other transaction details) and tells Proforma to process the order. Logo is either pulled off the back-end by Proforma or requested from Buyer, if not submitted.

Step 4: Buyer receives VIRTUAL PROOF from Proforma to approve for each item ordered. Buyer must approve proof via email (in writing) before factory produces the item.

Step 5: Buyer receives Tracking email, once the order is shipped.

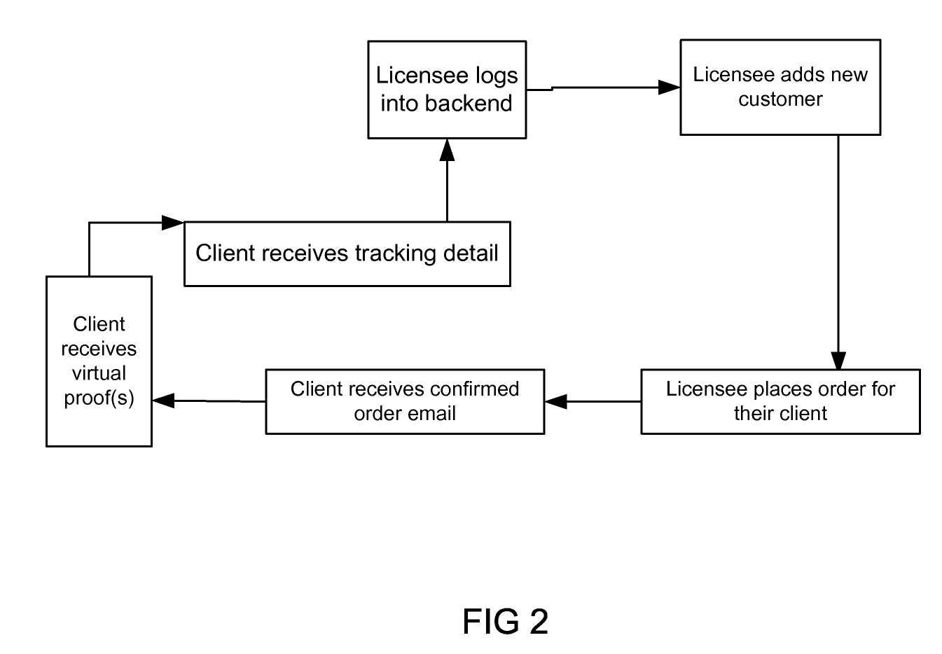

Now, let's look at the orders and the corresponding process, as shown in FIG. 2. For Orders Placed on the Backend by the Rep for their Client:

Step 1: Rep Logs into OnSalePromos.com/admin (with provided user name and password)

Step 2: Rep creates a NEW CUSTOMER under Sales/Customer/Add New Customer.

Step 3: Rep Enters Places New Order, by clicking Sales/Orders/New Order. Once the order is completed, the CREATE ORDER button is clicked. This moves the order into the SALES Folder and sets the status as PENDING.

Step 4: Rep finds the order that he/she just entered, double checks all details/costs/other information, then clicks CONFIRM ORDER button. This sends/triggers the OSP CONFIRMED ORDER Email to the Buyer.

Step 5: Client receives “OSP CONFIRMED ORDER” Email—it is the Order Approval. This lets the buyer know that the order details have been reviewed, and they need to now click the CONFIRM ORDER (or CANCEL) button to have their order released to the factory. When the buyer clicks the button, the sales rep gets an email called “OSP CONFIRMED ORDER”, which tells Rep that they just made a sale (& $$$, e.g. dollar amount and other transaction information, such as time, date, method, names, parties, tracking info, verification info, qualification info, approval info, authentication info, type of transaction, or institution names, if needed, for different embodiments), and tells Proforma to process the order. Logo is either pulled off backend by Proforma or requested from Buyer, if not submitted.

Step 6: Client receives VIRTUAL PROOF from Proforma to approve for each item ordered. Buyer must approve proof via email (in writing) before factory produces the item.

Step 7: Client receives Tracking email once the order is shipped.

Appendix 1 shows an email for orders@onsalepromo.com, which matches 10 ideas for the request submitted by the user, and lists them for the user to review (pages 1-2). On page 3, it shows the approval process. On page 4, it shows the shipping info. On page 5, it shows customer info and charges, plus order info. On page 7, it shows order estimate and related info. On page 9, it shows shipping info. On page 10, it shows order approval. On page 11, it shows confirmation of order. On page 12, it shows pending order.

Appendix 2 shows monthly targets, for various plays. Appendix 3 shows checklist for setting up the office and infrastructure (page 1), buying process (page 2), how the money is made (page 3), check list for managing business (page 4), customer matrix (page 5), and 3-year financial projections (page 10).

Appendix 4 shows how the main page of web site looks like as an example. Appendix 5 shows how the main page of web site looks like as an example, for a template, for various components, on screen, for the user to see and interact with.

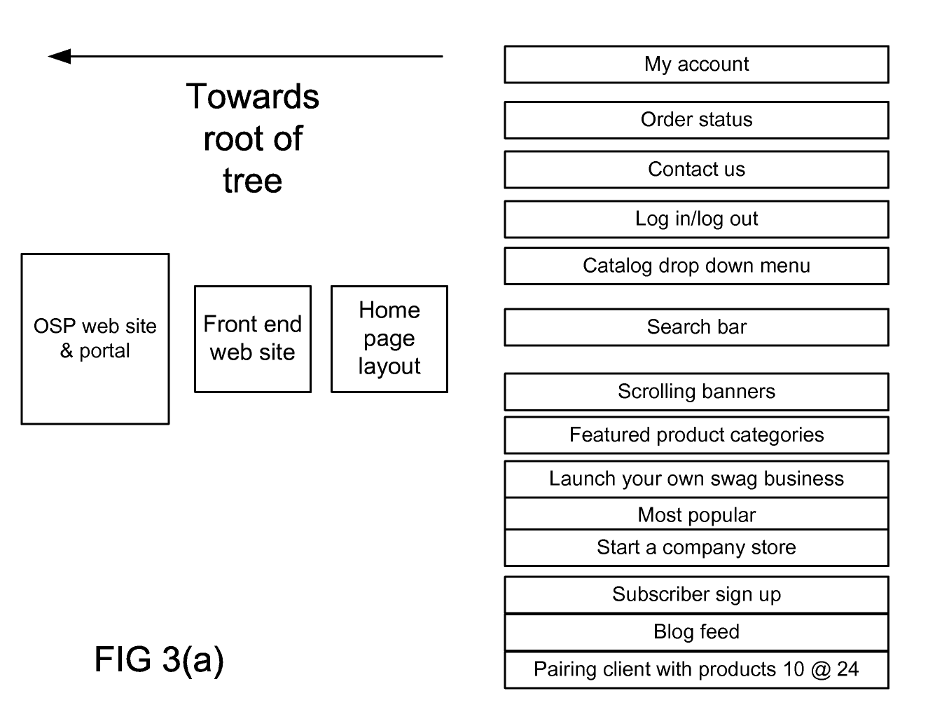

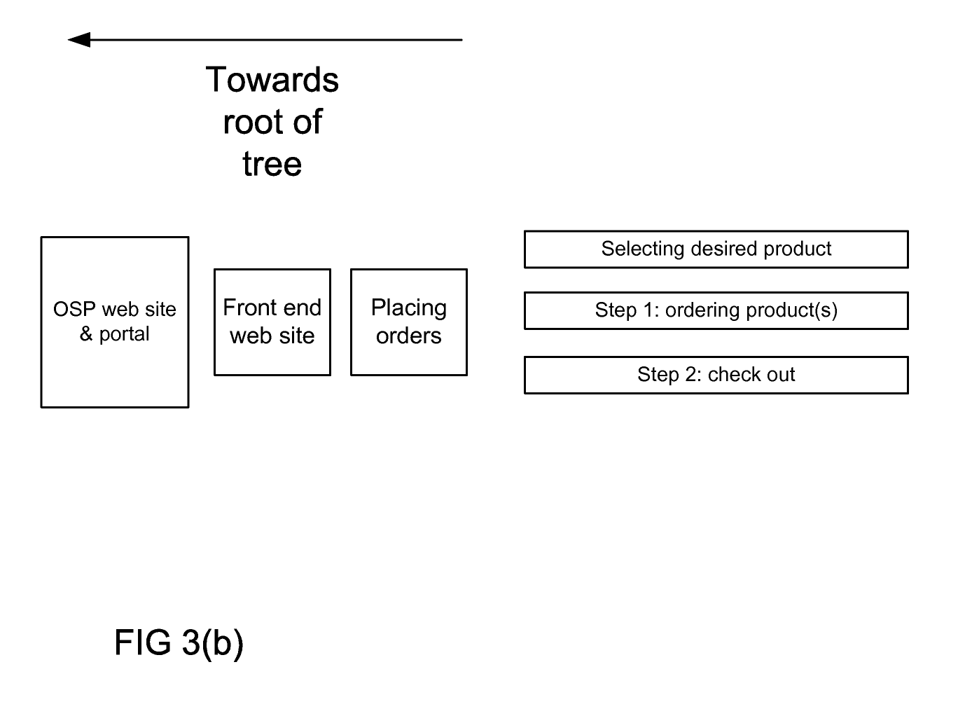

FIG. 3 (with all parts), plus the tables/tree structures given below, show various components of various parts of the front end web site and the back end portal, with all details, and their connections/relationships, as shown in the tree structure. Please see below for details, for tree structure, going from root, to outer leaves, as divided as branches/choices/sub-sections/sub-menus/sub-categories: (Please note that OSP website and portal is divided into: front end web site & backend portal, as shown below, in details.)

### On the Front End Web Site, We Have:

My Account is divided into: billing address, shipping address, previous orders, sample requests, saved searches.

Search bar, including Advanced search, is divided into: keywords, categories, themes, color, price per unit, quantity, production time, add on search options.

Add on search options is divided into: made in the USA, environmentally friendly, include rush.

Featured product categories is divided into: Blocks 1 through 5.

Select desired product is divided into: product description, product SKU, product review, color options, decoration method, imprint area, production time, product pricing grid, similar products, rate this product, request a sample, share via social media links.

Step 1, Ordering products, is divided into: select quantity, product color, imprint info, logo colors, add your logo, virtual proof, order notes, add to cart.

Step 2, Checkout, is divided into: billing address (& shipping address, check box, if the same), shipping address (divided into: shipping account (option) & in hands date), payment (divided into: credit card & invoice (option)), checkout/confirm order (summary) (divided into: discount code (option) & edit order (option)), submit order button (thank you page, explaining order process) (divided into: new order estimate email, confirmed order email/order approval, virtual proof email).

### On the Backend Portal, We Have:

The Backend portal is divided into: dashboard, catalog, sales, system, view store.

Dashboard is divided into: individual reports & consolidated summary reports.

Individual reports is divided into: sales reports (which is divided into: weekly sales report, monthly sales productivity report, year to date sales reports, sales contest reports, sales by customer reports/online stores reports, sales by month reports) & financial reports (which is divided into: monthly commission reports, profitability reports, P&L report).

Consolidated summary reports is divided into: combined licensee sales and pipeline reports/weekly, combined licensee sales and pipeline reports/monthly, combined online store reports, sales contest tracker.

Catalog is divided into: categories, products (which is divided into: OSP products, add new products, search SAGE), suppliers (which is divided into: OSP suppliers, add supplier, SAGE suppliers).

Sales is divided into: orders (which is divided into: new order/create order form (which is divided into: customer info, order info, order totals), orders (which is divided into: pending orders/sales check list/backend plug in/image forms (which is divided into: factory price/stock check & confirm sell pricing (divided into: order approval email to buyer & order moves into confirm orders folder)), confirmed orders (divided into: customer order approval request & view order option), approved orders/picked up and processed by back office partner (divided into: purchase order to factory, process button, update order button/order moves into processed orders folder), processed orders (divided into: virtual proof approval, ship button, update order button/order moves into shipped orders folder), shipped orders (divided into: customer order tracking email/personalized online marketing funnel triggered (divided into: personalized promotions of like products, monthly deal promotions, 11 month later reorder button email), customer invoiced by back office partner, view button, reorder button), archived orders/sorted by customer, date, or product ordered), canceled orders), customers (divided into: OSP customers/customer profiles, sample requests (divided into: lead sent to licensee/auto-distributed & personalized online marketing campaign triggered), subscribers (divided into: lead sent to licensee/auto-distributed & personalized online marketing campaign triggered), customer groups), coupons, tax rates.

The system is divided into: settings, accounts/add account (divided into: sales rep, administrator, 3^{rd} party vendor, affiliate), design (divided into: content/blocks, banners (divided into: OSP banners & add banner), blocks (divided into: design blocks & add blocks)).

In one embodiment, the central unit or company helps and coaches the first company (who has its own clients) to outsource or provide or buy promotional products for them. The first company pays the membership fee or licensing fees every month or quarter or year, to the central unit or company. In one embodiment, the central unit or company has its network of the fulfillment houses (one or more), to order the merchandise or products, through hundreds or thousands of factories or manufacturers, which ship the products directly or indirectly to the end user through one or more of the above intermediary steps or actors or partners or agents. In one embodiment, the shipping and bundling of the products are done by batch process or at certain time or periodically, e.g. at the end of each month or week.

In one embodiment, we have, as an example, Swagcoach.com and Onsalepromos.com, which work together. In one embodiment, we have, as an example, XML language for communication and commands or rules. In one embodiment, we have catalog for ordering or order entry system. The user-interface and GUI, background processing, and business methods presented here, are all novel. In one embodiment, we have catalog for promotional ideas, based on the history and characteristics of the user, suggested or presented to the user, automatically, including, e.g.: awards, plaques, apparel, clothing, T-shirts, backpacks, coolers, bags, calendars, books, electronics, sports, hats, caps, or the like.

In one embodiment, we have menu on the screen for: dashboard, catalog, sales, system, and view store, plus the choices: admin, sales, and orders, with sales menu divided as: pending orders, confirmed orders, approved orders, processed orders, and shipped orders, e.g. indicating “2 records found”. It also displays: number, order date, customer name, order number, product, amount, PO No., and action, as menu options, as examples, e.g. announcing: “2 pending orders found”, on the screen, for the user.

In one embodiment, we have overview, for example, showing: total sales, current month sales, sales margin, total customers, total orders, average order size, and commissions earned, on computer monitor, for menus available, with bar diagram plotted for better review and comparisons. In one embodiment, we have Swagcoach showing/coaching people how to work from home or for themselves, e.g. displaying menus for the following items: about us, press, articles, contact us, application, and search.

In one embodiment, we have for:

Front End:

Product search tools:
Search bar
Drop down category listing
10@24: ten ideas automatically emailed in 24 hours
XML data stream custom coded to allow buyer to search and buy over 750,000 products

Template:

Customized for private labeling, with a template to add in logo, phone number, custom categories, custom products, and custom branding, which is plugged into a custom portal, through which the order is processed by any third party order processor.

Ordering: (once product(s) are decided by the buyer)
Select products
Request a sample or place order
Choose quantity
Choose product color
Choose imprint info
Choose logo color(s)
Email or upload logo
Virtual proof, as optional
Other order notes, as optional
Add to cart
Check out: billing, shipping, payment info
Submit order: summary review

Once order placed by the buyer: 3 step processing system:
1—New order email: confirming estimated costs to the buyer
2—Confirmed order email: pricing reviewed by customer service team, then buyer gets an email with CONFIRM ORDER button. Once clicked, order is processed by back office and placed with factories.
3—Virtual proof email: sent to the buyer, to show what each products ordered looks like with their logo. Client approves and then the factory produces.

Two more emails:
1—email to client advising when their order will ship
2—email to client with order tracking details

Backend Details:
i. Displaying: dashboard, catalog, sales, system, view store

Descriptions:

Dashboard: showcases snapshot of total sales, customers, orders, or the like.

Catalog:
Categories: breakdown of product categories, and option to add on its own categories.
Products:
a. XML db that can be searched with over 700,000 products. Search using supplier, SKU, price, description, or the like.
b. Add new product feature.
Suppliers:
a. same as (a) above
b. add new supplier feature

Sales:
Orders: order entry process for entering new orders
Customers:
a. sample request DB (database or listing): review client and prospect request for samples made from front end
b. subscribers: review subscriber sign ups from front end
Coupons: set discount
Tax rates: ties into state tax rates, from a DB, which can be updated yearly, or as needed

System:
Settings: personalize store with contact info, logos, back office CSR rep for the store, and the like.
Accounts: access to the store, set ups, tags, and account type, which limits access
a. Sales rep: can create orders and change order status on limited basis
b. Admin: can create orders, cancel, change status, change products, and the like.
Design: change colors, categories, limited layout of template, content change, banner upload, block layouts, and the like.

Ordering process:

In one embodiment, we have the following options, on menu or buttons: pending orders, conformed orders, approved orders, processed orders, and shipped orders. Here are the steps for the process:
Step 1: Order created: (by rep on back end or client on front end) They click CREATE ORDER button. Then, it moves the order to “pending order” status and folder.
Step 2: Pricing reviewed by the customer service team: (back office partner)
a. When order created, CSR gets an email notifying them that there is a new order to review all pricing.
b. Once CSR reviews and confirms the pricing, they click “confirm pricing” button, which emails rep and let them know that their order has been reviewed and all pricing is good.
c. Rep updates sale prices, if necessary, and then clicks CONFIRM order button, which sends a custom email to the client to now approve their order. (Order moves to the “confirmed orders” folder.)
Step 3: client approval:
a. Client reviews and checks Confirm Order button in their email, and the order copy is sent to the rep and CSR to let them know the sale/order has been approved.
b. Order is moved to the Approved Orders folder/section/status.
Step 4: order processed with factory: CSR picks up order and places it with factory. It gets acknowledgement and proof, which is sent to the client for approval. PO is entered and the order is moved to the Processed Order Folder.
Step 5: skipped orders:
a. Once CSR gets tracking number from factory, it enters in the order, and this triggers an email to the client (and to the rep.) with tracking info, to let them know that the order has been shipped.
b. Order moves into Shipped Orders folder, where it is archived by month, customer, and the like.
c. A re-order button is linked to the order, should the rep want to place a re-order for the client.

Note: As the order moves through each Folder in the order process, the client can review this on the front end under My Account, when they log in.

In the event that the client has never ordered from the front end, the front order placed by the Rep. (representative) on the backend automatically creates an account for the client, and they are emailed their account info.

In one embodiment, we have a method for promotional products order processing through a network or Internet, which comprises the following steps: a representative logging into a site as an administrator with a user name and a password; the representative creating a new-customer account, under new-customer folder; accessing one or more factory product databases; accessing history database for a buyer; accessing preference database for the buyer; suggesting one or more products from one or more factory product databases, based on history database for a buyer and preference database for buyer; selecting from one or more products; adding one or more objects to shopping cart; completing an order, chosen from one or more products and one or more objects; clicking create-order button on a menu for a user-interface on a display; a processor module/microprocessor moving order into sales folder; processor module setting status to pending; finding order; checking details of order; clicking confirm-order button; sending a first confirmed-order email to buyer; confirming order; releasing order to a factory; representative receiving a second confirmed-order email, stating occurrence of a transaction, value of transaction, and details of transaction; storing second confirmed-order email in a confirmation email storage; instructing processing of order; either pulling off a logo from backend, or requesting logo from buyer; receiving virtual-proof; displaying virtual-proof; approving each item ordered; buyer sending an approval email; customizing each item ordered with instructions, figure, and text, provided by buyer, for promotional purpose; factory producing each item ordered; shipping each item ordered to buyer; and buyer receiving a tracking email for shipment of each item ordered to buyer.

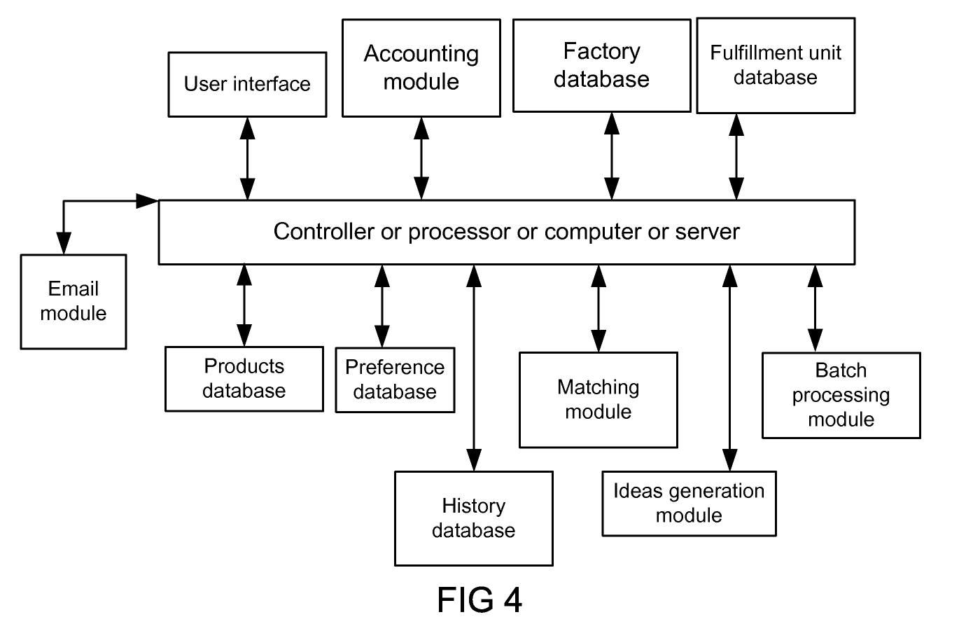

FIG. 4 shows a typical system with components and subsystems or modules or hardware implementing an embodiment of the invention. The system, in one example, comprises a microprocessor or processor unit or module(s), a storage(s), a database(s), a memory unit, a RAM, a ROM, a buffer, calculation unit, display unit, user interface, GUI, monitor, key board, command interpretation unit, prioritization unit or module, notification unit(s), acknowledgement module(s), and accounting unit.

Any variations of the above teachings are also intended to be covered by this patent application.

1. A method for promotional products order processing through a network, said method comprising:
a representative logging into a site as an administrator with a user name and a password;
said representative creating a new-customer account, under new-customer folder;
accessing one or more factory product databases;
accessing history database for a buyer;
accessing preference database for said buyer;
suggesting one or more products from said one or more factory product databases, based on said history database for a buyer and said preference database for said buyer;
selecting from said one or more products;
adding one or more objects to shopping cart;
completing an order, chosen from said one or more products and said one or more objects;
clicking create-order button on a menu for a user-interface on a display;
a processor module moving said order into sales folder;
said processor module setting status to pending;
finding said order;
checking details of said order;
clicking confirm-order button;
sending a first confirmed-order email to said buyer;
confirming said order;
releasing said order to a factory;
said representative receiving a second confirmed-order email, stating occurrence of a transaction, value of said transaction, and details of said transaction;
storing said second confirmed-order email in a confirmation email storage;
instructing processing of said order;
either pulling off a logo from backend, or requesting said logo from said buyer;
receiving virtual-proof;
displaying said virtual-proof;
approving each item ordered;
said buyer sending an approval email;
customizing said each item ordered with instructions, figure, and text, provided by said buyer, for promotional purpose;
said factory producing said each item ordered;
shipping said each item ordered to said buyer; and
said buyer receiving a tracking email for said shipment of said each item ordered to said buyer.

2. The method for promotional products order processing through a network as recited in claim 1, said method comprises: sending ideas through email.

3. The method for promotional products order processing through a network as recited in claim 1, said method comprises: giving feedback through email.

4. The method for promotional products order processing through a network as recited in claim 1, said method comprises: making changes on said order.

5. The method for promotional products order processing through a network as recited in claim 1, said method comprises: displaying customer account.

6. The method for promotional products order processing through a network as recited in claim 1, said method comprises: displaying search bar for products.

7. The method for promotional products order processing through a network as recited in claim 1, said method comprises: scrolling banners.

8. The method for promotional products order processing through a network as recited in claim 1, said method comprises: displaying featured products.

9. The method for promotional products order processing through a network as recited in claim 1, said method comprises: displaying customer groups.

10. The method for promotional products order processing through a network as recited in claim 1, said method comprises: displaying suppliers.

11. The method for promotional products order processing through a network as recited in claim 1, said method comprises: displaying factories.

12. The method for promotional products order processing through a network as recited in claim 1, said method comprises: displaying fulfillment centers.

13. The method for promotional products order processing through a network as recited in claim 1, said method comprises: choosing suppliers.

14. The method for promotional products order processing through a network as recited in claim 1, said method comprises: choosing fulfillment centers.

15. The method for promotional products order processing through a network as recited in claim 1, said method comprises: consolidating reports.

16. The method for promotional products order processing through a network as recited in claim 1, said method comprises: batch processing reports.

17. The method for promotional products order processing through a network as recited in claim 1, said method comprises: batch processing orders.

18. The method for promotional products order processing through a network as recited in claim 1, said method comprises: batch processing approved sales.

19. The method for promotional products order processing through a network as recited in claim 1, said method comprises: batch processing based on a periodic schedule.

20. The method for promotional products order processing through a network as recited in claim 1, said method comprises: batch processing based on a date.
